(19) United States
(12) Patent Application Publication
(10) Pub. No.: US 2021/0305722 A1
(43) Pub. Date: Sep. 30, 2021

(54) Broadband Dual-Polarization Filtering Base Station Antenna Unit, Base Station Antenna Array and Communication Device

(71) Applicant: SOUTH CHINA UNIVERSITY OF TECHNOLOGY, Guangzhou, Guangdong (CN)

(72) Inventors: Xiuyin ZHANG, Guangzhou (CN); Chaofeng DING, Guangzhou (CN); Yiyang LIU, Guangzhou (CN); Yunfei CAO, Guangzhou (CN); Quan XUE, Guangzhou (CN)

(73) Assignee: SOUTH CHINA UNIVERSITY OF TECHNOLOGY, Guangzhou, Guangdong (CN)

(21) Appl. No.: 17/265,538

(22) PCT Filed: Mar. 11, 2020
(86) PCT No.: PCT/CN2020/078707

§ 371 Date: Feb. 3, 2021

(30) Foreign Application Priority Data
Jul. 29, 2019 (CN) 201910687521.1

(51) Int. Cl. H01Q 21/26; H01Q 1/24; H01Q 1/48

(52) U.S. Cl. CPC H01Q 21/26; H01Q 1/48; H01Q 1/246

(57) ABSTRACT

The invention discloses a broadband dual-polarization filtering base station antenna unit, a base station antenna array and a communication device, the antenna unit comprising four dipole arms, four parasitic branches and a feed structure, wherein two of the dipole arms are arranged oppositely, the other two dipoles are also arranged oppositely, the four dipole arms correspond to the four parasitic branches respectively, each dipole arm is coupled to a corresponding parasitic branch, the feed structure is connected with the four dipole arms; the antenna array comprising at least two antenna units described above; the communication device comprising the antenna unit described above, or comprising the antenna array described above. Not only the radiation performance of the present invention may achieve high roll-off filtering characteristics and high polarization isolation, but also to a great extent ensuring that no introduction of additional insertion loss and occupied area caused by redundant structures, and the bandwidth may be expanded, the height reduced, and a stable pattern in a wide frequency band is achieved.

### CROSS-REFERENCE TO RELATED APPLICATIONS

This is the U.S. National Stage of International Patent Application No. of PCT/CN2020/078707 filed on Mar. 11, 2020, which in turn claims the benefit of Chinese Patent Application No. 201910687521.1 filed on Jul. 29, 2019.

### TECHNICAL FIELD

The invention relates to a broadband dual-polarization filtering base station antenna unit, base station antenna array and communication device, and belongs to the field of wireless communication.

### TECHNICAL BACKGROUND

In recent years, besides optimizing antenna configurations, filtering dipole antennas have also been used to reduce out-of-band coupling in multi-band base station antenna systems. In order to realize filtering antennas, the traditional method is to cascade a filter circuit and the antenna, and the last-stage resonator is replaced by an antenna radiator. However, the insertion loss caused by the additional filter circuit will reduce the antenna gain or efficiency. To avoid this problem, the filter structure is integrated with a single-polarized antenna radiator, comprising short-circuit vias and U-shaped grooves, C-shaped grooves and hyper-curved structures.

In the existing dual-polarization filtering dipole antenna design, it is necessary to consider how to expand the bandwidth, reduce the height, and realize the frequency selectivity of the passband edge with fast roll-off and certain out-of-band suppression capabilities. In addition, it is also required to achieve high polarization isolation between the two ports of the dual-polarized antenna unit and that the antenna unit has miniaturization characteristics.

There is no additional filter circuit in the design of the new dual-polarization filtering patch antenna in specific literature such as “Zhang X. Y., Xue D., Ye L. H., et al. Compact Dual-Band Dual-Polarized Interleaved Two-Beam Array With Stable Radiation Pattern Based on Filtering Elements [J]. IEEE Transactions on Antennas and Propagation, 2017, 65(9): 4566-4575”. Although it achieves a low profile, its bandwidth is limited. There is also a design in “C.-F. Ding, X.-Y. Zhang, Y. Zhang, Y.-M. Pan and Q. Xue, “Compact broadband dual-polarized filtering dipole antenna with high selectivity for base station applications,” IEEE Transactions on Antennas and Propagation, 2018, 66 (11): 5747-5756” that proposes a broadband filtering dual-polarized antenna with two parasitic loops, but this design requires multiple filtering structures, complex feed baluns and additional substrates.

The invention patent application with Chinese Patent Application Publication No. CN106099352A “A compact multi-frequency base station antenna array” realizes the filtering function, but the patent application does not realize dual polarization, and has the problem of insufficient operating bandwidth.

### SUMMARY OF THE INVENTION

The first objective of the present invention is to provide a broadband dual-polarization filtering base station antenna unit in order to solve the above-mentioned defects of the prior art. Not only the radiation performance of the antenna unit may achieve high roll-off filtering characteristics and high polarization isolation, but also to a great extent ensuring that no introduction of additional insertion loss and occupied area caused by redundant structures, and the bandwidth may be expanded, the height reduced, and a stable pattern in a wide frequency band is achieved.

The second objective of the present invention is to provide a base station antenna array.

The third objective of the present invention is to provide a communication device.

The first objective of the present invention may be achieved by adopting the following technical solutions:

A broadband dual-polarization filtering base station antenna unit, comprising four dipole arms, four parasitic branches and a feeding structure, wherein two of the dipole arms are arranged oppositely, the other two dipoles are also arranged oppositely, the four dipole arms correspond to the four parasitic branches respectively, each dipole arm is coupled to a corresponding parasitic branch, the feed structure is connected with the four dipole arms.

Further, a size of each dipole arm is used to control a frequency position of an upper stopband radiation null, and a size of each parasitic branch is used to control a frequency position of a lower stopband radiation null, a coupling amount between each dipole arm and the corresponding parasitic branch and a size of the parasitic branches are used to achieve independent controllable band-pass filtering of a radiation suppression null.

Further, the coupling amount between each dipole arm and the corresponding parasitic branch is controlled by the size of the dipole arm and a spacing between the dipole arm and the corresponding parasitic branch.

Further, the feed structure comprises two mutually orthogonal baluns, each balun comprises a feed line, an end of the feed line is connected with a coaxial line.

Further, each balun further comprises a substrate, the feed line is arranged on a front surface of the substrate, and a back surface of the substrate is a ground plane.

Further, a height of the substrate is a quarter of a wavelength corresponding to a center frequency of the antenna unit.

Further, the feed structure is a dual-polarization balun. The dual-polarization balun has four faces. Any two adjacent faces are respectively provided with a feed line and an open-circuit microstrip line. An upper end of the feed line is connected to an upper end of the open-circuit microstrip line through a metal rod. A lower end of the feed line is connected to the coaxial line.

Further, the parasitic branches are U-shaped structures, C-shaped structures, V-shaped structures or top hat-shaped structures.

Further, the antenna unit is in a crossed dipole form, a bowl-shaped dipole form, a slot antenna form or a patch antenna form.

The second objective of the present invention may be achieved by adopting the following technical solutions:

A base station antenna array, comprising at least two antenna units described above.

The third objective of the present invention may be achieved by adopting the following technical solutions:

A communication device, comprising the antenna unit described above, or comprising the antenna array described above.

Compared with the prior art, the present invention has the following beneficial effects:

1. The antenna unit of the present invention is provided with four dipole arms and four parasitic branches, wherein two of the dipole arms are arranged oppositely to form a polarized dipole arm. The other two dipole arms are also arranged oppositely to form another polarized dipole arm. The four dipole arms correspond to four parasitic branches respectively, and each dipole arm is coupled to a corresponding parasitic branch, which may generate two radiation nulls in the lower stop band and the upper stop band respectively, resulting in good broadband radiation characteristics and high roll-off band-pass filtering effects. Its cost is low and its structure is simple. No additional filter circuit is needed. Only by loading parasitic branches on the dipole arms, it can increase the bandwidth while introducing a high roll-off edge filtering effect.

2. The antenna unit of the present invention may control the frequency of the upper stopband radiation null by adjusting the size of the dipole arms, and may control the frequency of the lower stopband radiation null by adjusting the size of the parasitic branches, to achieve good band-pass filter characteristics and almost no additional loss, and by adjusting the amount of coupling between the dipole arms and the parasitic branches and the size of the parasitic branches, bandpass filtering with independent controllable radiation suppression null may be realized, that is, the filter band-pass frequency may be freely and independently changed.

3. The antenna unit of the present invention has good radiation performance in the pass band. Through the band-pass filtering effect with high roll-off and good out-of-band suppression ability outside the pass band, the way to achieve filtering performance does not bring additional processing costs and is widely applicable, and without introducing additional insertion loss. It has the characteristics of wide operating frequency band, high gain, low cross polarization, and the feed structure of the different polarization ports is almost completely symmetrical and has high isolation, while achieving stable radiation pattern in a wide frequency band.

4. The antenna unit or antenna array of the present invention may adjust the size of the relevant structure according to requirements and adapt to the transmitting and receiving equipment of the wireless communication system of different frequency bands. Due to the filtering characteristics of the antenna unit or antenna array, it is particularly suitable for open and complex communication scenarios. It also benefits from the integration of the filtering characteristics and radiation characteristics of the antenna unit or antenna array, and it is also suitable for all-in-one and integration of communication equipment.

### DESCRIPTION OF THE FIGURES

In order to explain the embodiments of the present invention or the technical solutions in the prior art more clearly, the following will briefly introduce the figures that need to be used in the description of the embodiments or the prior art. Obviously, the figures in the following description are only some embodiments of the present invention. For those of ordinary skill in the art, other figures may be obtained from these drawings without inventive work.

FIG. 1 is a three-dimensional structural diagram of a broadband dual-polarization filtering base station antenna unit according to Embodiment 1 of the present invention.

FIG. 2 is a top view structural diagram of a broadband dual-polarization filtering base station antenna unit according to Embodiment 1 of the present invention.

FIG. 3 is a side view structural diagram of a broadband dual-polarization filtering base station antenna unit according to Embodiment 1 of the present invention.

FIG. 4 is a structural diagram of a radiator according to Embodiment 1 of the present invention.

FIG. 5 is a structural diagram of a balun of Embodiment 1 of the present invention.

FIG. 6 is a result diagram of the reflection coefficient S11-frequency and the transmission coefficient S21-frequency of Embodiment 1 of the present invention.

FIG. 7 is a comparison diagram of simulation and measurement results of peak gain-frequency in Embodiment 1 of the present invention.

FIG. 8 is a diagram of an array form of a base station antenna array according to Embodiment 2 of the present invention.

FIG. 9 is a diagram of an array form of a base station antenna array according to Embodiment 3 of the present invention.

FIG. 10 is a diagram of an array form of a base station antenna array according to Embodiment 4 of the present invention.

FIG. 11 is a diagram of an array form of a base station antenna array according to Embodiment 5 of the present invention.

FIG. 12 is a three-dimensional structural diagram of a broadband dual-polarization filtering base station antenna unit according to Embodiment 6 of the present invention.

FIG. 13 is a top view structural diagram of a broadband dual-polarization filtering base station antenna unit according to Embodiment 6 of the present invention.

FIG. 14 is a side view structural diagram of a broadband dual-polarization filtering base station antenna unit according to Embodiment 6 of the present invention.

FIG. 15 is a three-dimensional structural diagram of a broadband dual-polarization filtering base station antenna unit according to Embodiment 7 of the present invention.

FIG. 16 is a top view structural diagram of a broadband dual-polarization filtering base station antenna unit according to Embodiment 7 of the present invention.

FIG. 17 is a side view structural diagram of a broadband dual-polarization filtering base station antenna unit according to Embodiment 7 of the present invention.

where 1—dielectric plate, 2—feed structure, 201—substrate, 202—feed line, 3—first dipole arm, 4—second dipole arm, 5—third dipole arm, 6—fourth dipole arm, 7—first parasitic branch, 8—second parasitic branch, 9—third parasitic branch, 10—fourth parasitic branch, 11—reflector, 12—first antenna unit, 13—second antenna unit, 14—third antenna unit.

### DETAILED DESCRIPTION

The following will clearly and completely describe the technical solutions of the embodiments of the present invention with reference to the accompanying figures of the embodiments of the present invention. Obviously, the described embodiments are only a part of the embodiments of the present invention, rather than all of the embodiments. Based on the embodiments of the present invention, all other embodiments obtained by those of ordinary skill in the art without inventive work shall fall within the protection scope of the present invention.

### Embodiment 1

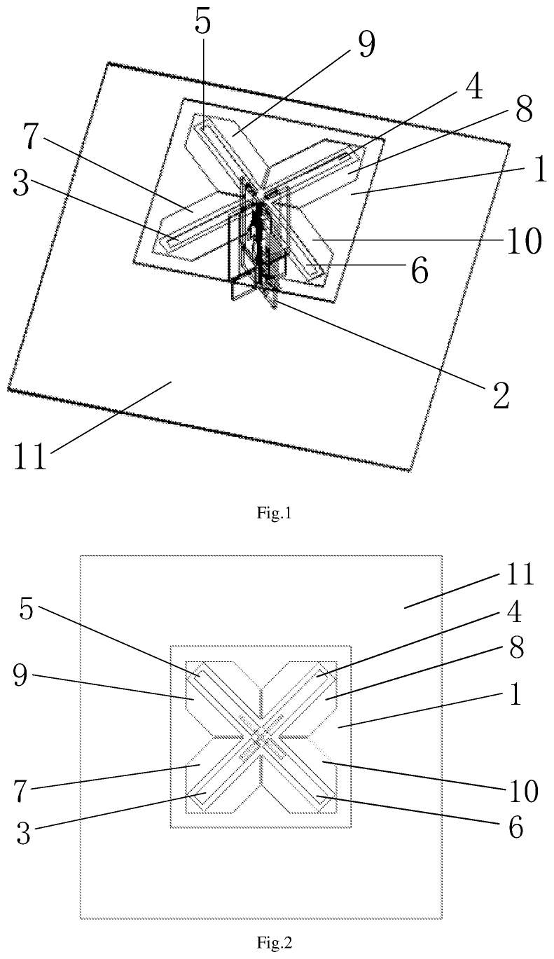

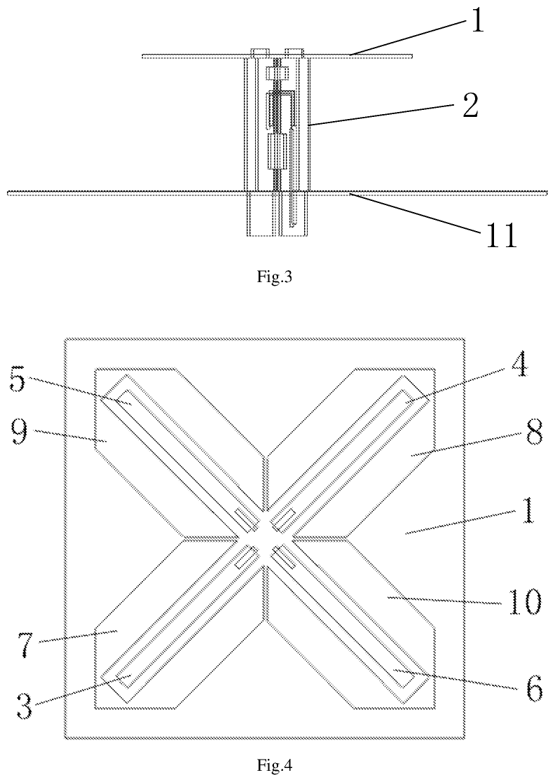

As shown in FIGS. 1 to 4, this embodiment provides a broadband dual-polarization filtering base station antenna unit. The antenna unit comprises four dipole arms, four parasitic branches, dielectric plate 1 and feed structure 2. The four dipole arms and the four parasitic branches may be provided on the upper layer of the dielectric plate 1 by printing, die-casting etc. to form the radiators of the antenna unit. The four dipole arms are first dipole arm 3, second dipole arm 4, third dipole arm 5, and fourth dipole arm 6 respectively. The four parasitic branches are first parasitic branch 7, second parasitic branch 8, third parasitic branch 9 and fourth parasitic branch 10 respectively. The first dipole arm 3, second dipole arm 4, third dipole arm 5 and fourth dipole arm 6 correspond to the first parasitic branch 7, second parasitic branch 8, third parasitic branch 9 and fourth parasitic branch 10 respectively. The feed structure 2 supports and fixes in the dielectric plate 1.

Further, the first dipole arm 3 and the second dipole arm 4 are arranged oppositely to form +45° polarized dipole arms to become a dipole. The third dipole arm 5 and the fourth dipole arm 6 are arranged oppositely to form −45° polarized dipole arms to become another dipole. The two dipoles are orthogonal to each other, making the antenna unit a cross dipole form antenna unit. The first dipole arm 3 is coupled to the first parasitic branch 7, the second dipole arm 4 is coupled to the second parasitic branch 8, the third dipole arm 5 is coupled to the third parasitic branch 9, and the fourth dipole arm 6 is coupled to the fourth parasitic branch 10, which may generate radiation nulls in the upper and lower stop bands, resulting in good broadband radiation characteristics and high roll-off band-pass filtering effect.

Specifically, when the coupling amount between the dipole arms and the parasitic branches is determined, the frequency of the upper stopband radiation null can be controlled by adjusting the length of the dipole arms (the first dipole arm 3, the second dipole arm 4, the third dipole arm 5 and the fourth dipole arm 6), the frequency of the lower stop band radiation null can be controlled by adjusting the length of the parasitic branches (the first parasitic branch 7, the second parasitic branch 8, the third parasitic branch 9 and the fourth parasitic branch 10). Both radiation nulls are gain nulls to achieve good band-pass filtering characteristics and almost introducing no additional loss. By adjusting the coupling amount between the dipole arms and the parasitic branches and the length of the parasitic branches, bandpass filtering with independent controllable radiation suppression nulls may be realized, where the coupling between the dipole arms and the parasitic branches is controlled by the length of the dipole arms and the spacing between the dipole arms and the parasitic branches.

The first parasitic branch 7, the second parasitic branch 8, the third parasitic branch 9, and the fourth parasitic branch 10 in this embodiment are all U-shaped structures, but it is understandable that the first parasitic branch 7, the second parasitic branch 8, the third parasitic branch 9, and the fourth parasitic branch 10 may also be a C-shaped structure, a V-shaped structure, a top hat-shaped structure etc.

As shown in FIG. 5, the feed structure 2 of this embodiment comprises two mutually orthogonal baluns. The lower ends of the two baluns are connected to the reflector 11. The upper ends of one of the baluns are connected to the first dipole arm 3 and the second dipole arm 4 respectively. The upper ends of the other balun are connected to the third dipole arm 5 and the fourth dipole arm 6 respectively. Each balun comprises substrate 201 and feed line 202. Feed line 202 is placed on the front of the substrate 201 by printing, die-casting etc., and the lower end of the feed line 202 is connected to a 50 ohm coaxial line (also called a coaxial cable), specifically connected to the inner core of the coaxial line, as the input port (i.e. the feed port). The upper end of the feed line 202 is used as the output port. The back of the substrate 201 is a ground plane with a floor. The balun is a structural form connected by a jumper on a same substrate.

In order to achieve high gain, the height of substrate 201 is approximately a quarter of the wavelength corresponding to the central frequency of the antenna unit; in order to further improve the filtering performance of the antenna unit, a filter circuit may also be connected to the output port of the balun (the upper end of the feed line 202).

It may be understood that the feed structure 2 of this embodiment may also be a dual-polarization balun. The dual-polarization balun comprises four substrates, two of which are parallel to each other, with the other two substrates are also parallel to each other. The four substrates are used as the four faces of the dual-polarization balun. Any two adjacent faces are respectively provided with feeds and open-circuit microstrip lines. The upper end of a feed line is connected to the upper end of the open-circuit microstrip line through a metal rod, and the lower end of a feed line is connected to a 50 ohm coaxial line, specifically connected to the inner core of the coaxial line. The dual-polarization balun is a structural form comprising two sets of parallel substrates and connected by metal rods.

In the above embodiments, the first dipole arm 3, the second dipole arm 4, the third dipole arm 5, the fourth dipole arm 6, the first parasitic branch 7, the second parasitic branch 8, the third parasitic branch 9, and the fourth parasitic branch 10, the floor on the back of the balun substrate are made of metal patches. The metal material used may be any one of aluminium, iron, tin, copper, silver, gold and platinum, or an alloy of any one of aluminium, iron, tin, copper, silver, gold and platinum.

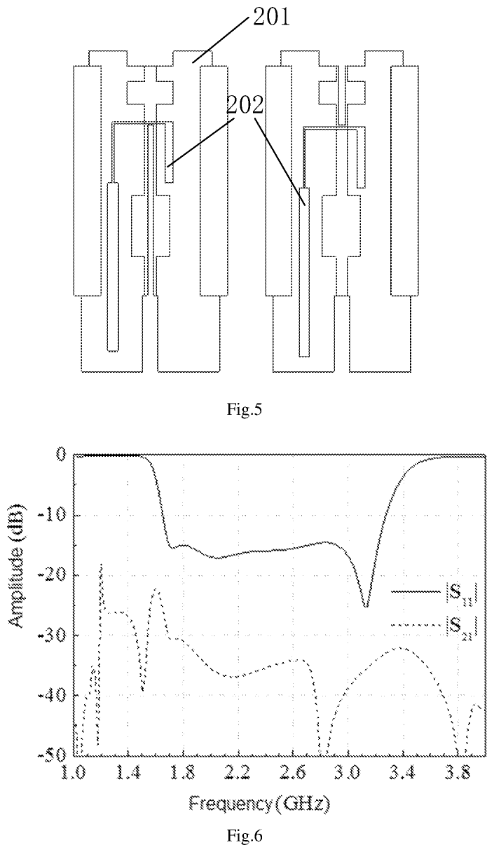

As shown in FIG. 6 are the results of reflection coefficient S11-frequency and transmission coefficient S21-frequency of the antenna unit of this embodiment. S11 represents the return loss of port 1. S21 represents the forward transmission coefficient of port 1 to port 2. As may be seen from the figures, the impedance matching in the passband is good. The impedance bandwidth is 1.7 GHz to 3.2 GHz. The return loss is below −15 dB; the isolation of the two ports in the passband is better, both below −30 dB.

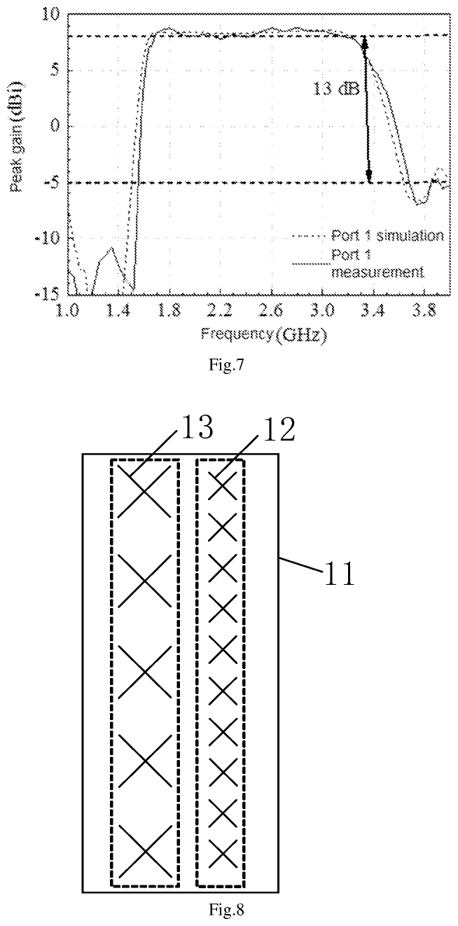

As shown in FIG. 7 is the peak gain-frequency comparison result diagram of the antenna unit of this embodiment in the simulation and measurement states. The gain in the operating frequency band is about 8 dBi. Both sides of the passband have high roll-off filtering characteristics, and it achieves filtering suppression exceeding 13 dB from 0.69 to 1.5 GHz and from 3.5 to 4 GHz; where loading parasitic branches on the dipole arms may generate two radiation nulls at the lower stopband and the upper stopband at the same time, achieving good bandpass filtering characteristics.

The antenna unit of this embodiment has the following advantages:

1) The antenna unit is in the form of crossed dipoles, with low cost and simple structure. No additional filter circuit is required. Only by loading parasitic branches on the dipole arms, the bandwidth may be increased while introducing high roll-off edge filtering effect.

2) The antenna unit may control the frequency of two gain nulls according to actual needs by adjusting the size of the dipole arms and the parasitic branches, thereby changing the filter band-pass frequency freely and independently.

3) The antenna unit has good radiation performance in the passband. Outside the passband has a band-pass filtering effect with high roll-off and good out-of-band suppression. The way to achieve the filtering performance does not bring additional processing costs and has a wide range of applications, and does not introduce additional insertion loss.

4) The antenna unit has the characteristics of wide operating frequency band, high gain, and low cross polarization, and the feed structures of the different polarization ports is almost completely symmetrical with high isolation, and at the same time, it realizes a stable pattern in the wide frequency band.

### Embodiment 2

As shown in FIG. 8, this embodiment provides a base station antenna array, which is a dual-frequency dual-polarized base station antenna array, comprising a reflector 11, at least one first antenna unit 12 with high selectivity, and at least one second antenna unit 13 operating in a low frequency band, that is, this embodiment is a dual-row antenna array. Two antenna units 13 are placed on the reflector 11, where the first antenna unit 12 is placed on one side of the reflector 12. The second antenna unit 13 is placed on the other side of the reflector 12, on the same horizontal plane. The antenna unit structure of this embodiment is the same as that of Embodiment 1.

### Embodiment 3

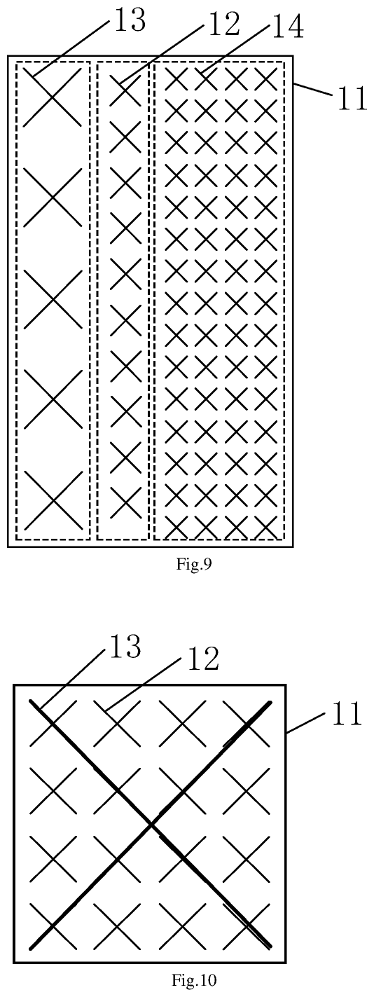

As shown in FIG. 9, this embodiment provides a base station antenna array, which is a multi-frequency dual-polarized base station antenna array, comprising a reflector 11, at least one first antenna unit 12 with high selectivity, at least one second antenna unit 13 operating in a low frequency band and at least one third antenna unit 14 operating in a high frequency band, that is, this embodiment is a multi-row antenna array. Three antenna units are placed on the reflector 11. The first antenna unit 12 is placed in the middle of the reflector 11. The second antenna unit 13 is placed on one side of the first antenna unit 12, and the third antenna unit 14 is placed on the other side of the first antenna unit 12 on the same horizontal plane. The antenna unit structure of this embodiment is the same as that of Embodiment 1.

### Embodiment 4

As shown in FIG. 10, this embodiment provides a base station antenna array, which is a dual-frequency dual-polarized base station antenna array, comprising a reflector 11, at least one first antenna unit 12 with high selectivity, and at least one second antenna unit 13 operating in a low frequency band, that is, this embodiment is a dual-row antenna array. The first antenna unit 12 is placed in the middle of the reflector 11, and the second antenna unit 13 is placed above the first antenna unit 12 to reduce the overall size of the antenna. The antenna unit structure of this embodiment is the same as that of Embodiment 1.

### Embodiment 5

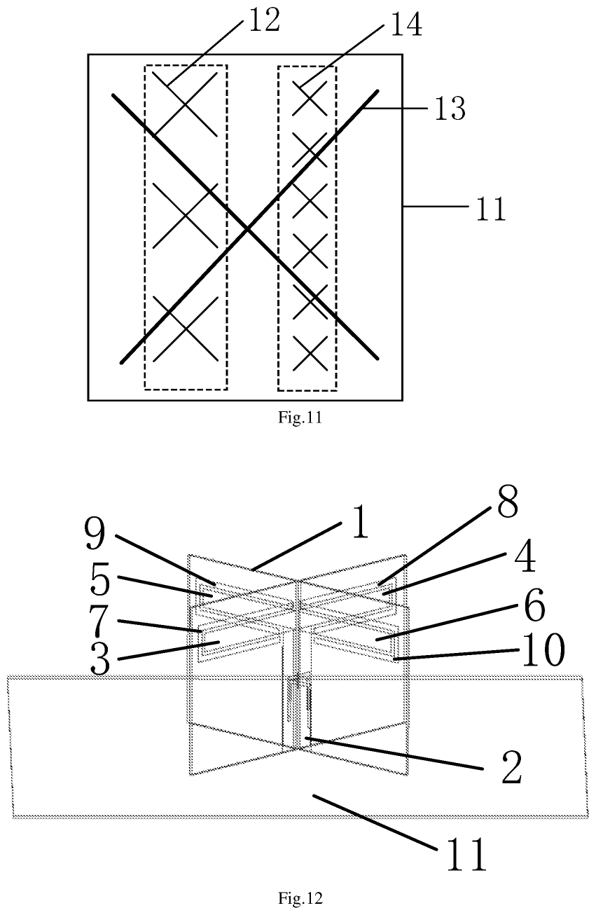

As shown in FIG. 11, this embodiment provides a base station antenna array, which is a multi-frequency dual-polarized base station antenna array, comprising a reflector 11, at least one first antenna unit 12 with high selectivity, at least one second antenna unit 13 operating in a low frequency band and at least one third antenna unit 14 operating in a high frequency band, that is, this embodiment is a multi-row antenna array. The first antenna unit 12 is placed on one side of the reflector 11. The third antenna unit 14 is placed on the other side of the reflector 11. The second antenna unit 13 is placed above the first antenna unit 12 and the third antenna unit 14. The antenna unit structure of this embodiment is the same as that of Embodiment 1.

### Embodiment 6

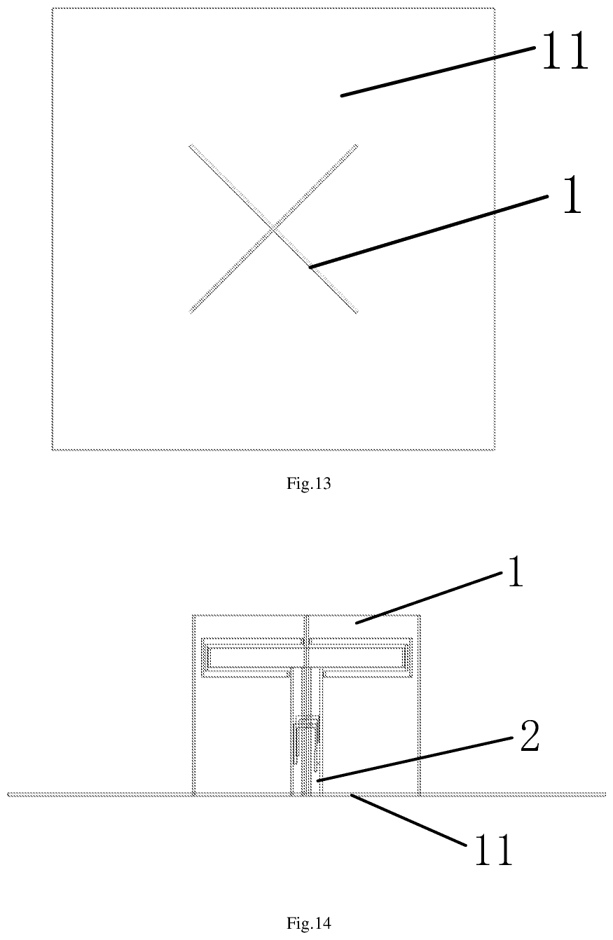

As shown in FIGS. 12 to 14, this embodiment provides a broadband dual-polarization filtering base station antenna unit. The antenna unit comprises four dipole arms, four parasitic branches, two dielectric plates 1 and a feed structure 2. Four dipole arms and four parasitic branches act as the radiators of the antenna unit. The four dipole arms are the first dipole arm 3, the second dipole arm 4, the third dipole arm 5 and the fourth dipole arm 6. The four parasitic branches are the first parasitic branch 7, the second parasitic branch 8, the third parasitic branch 9, and the fourth parasitic branch 10. The first dipole arm 3, the second dipole arm 4, the third dipole arm 5 and the fourth dipole arm 6 correspond to the first parasitic branch 7, the second parasitic branch 8, the third parasitic branch 9 and the fourth parasitic branch 10 respectively. The two dielectric plates 1 are orthogonal to each other and are placed on reflector 11. The feed structure 2 comprises two baluns that are orthogonal to each other. The first dipole arm 3, the second dipole arm 4, the first parasitic branch 7, the second parasitic branch 8 and one of the baluns are placed on one dielectric plate 1 through printing, die-casting etc. The third dipole arm 5, the fourth dipole arm 6, the third parasitic branch 9 and the fourth parasitic branch 10 and the other balun are placed on another piece of dielectric plate 1 through printing, die-casting etc.

Further, the first dipole arm 3 and the second dipole arm 4 are arranged oppositely to form +45° polarized dipole arms to become a dipole. The third dipole arm 5 and the fourth dipole arm 6 are arranged oppositely to form −45° polarized dipole arms to become another dipole. The two dipoles are orthogonal to each other, making the antenna unit a cross dipole form antenna unit. The first dipole arm 3 is coupled to the first parasitic branch 7. The second dipole arm 4 is coupled to the second parasitic branch 8. The third dipole arm 5 is coupled to the third parasitic branch 9. The fourth dipole arm 6 is coupled to the fourth parasitic branch 10. The lower ends of the two baluns are connected to the reflector 11. The upper ends of one of the baluns are connected to the first dipole arm 3 and the second dipole arm 4 respectively.

The upper ends of the other balun are connected to the third dipole arm 5 and fourth dipole arm 6 respectively.

In this embodiment, the first parasitic branch 7, the second parasitic branch 8, the third parasitic branch 9, and the fourth parasitic branch 10 are all U-shaped structures. The first parasitic branch 7 and the second parasitic branch 8 are asymmetrical. The third parasitic branch 9 and the fourth parasitic branch 10 are asymmetrical. The filtering performance of the antenna unit is improved by adjusting the parasitic branches to an asymmetrical form. The entire antenna unit has the characteristics of simple structure, wide operating bandwidth, and high filtering performance.

### Embodiment 7

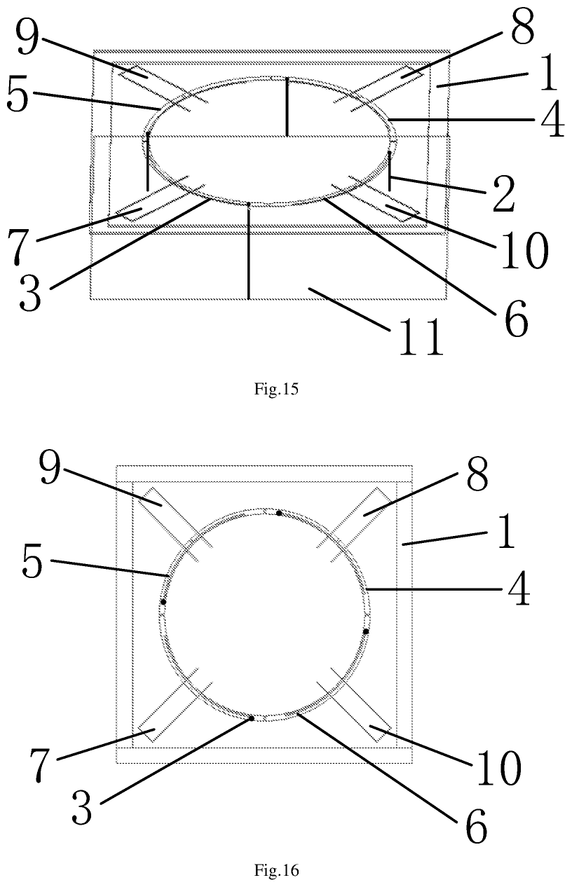

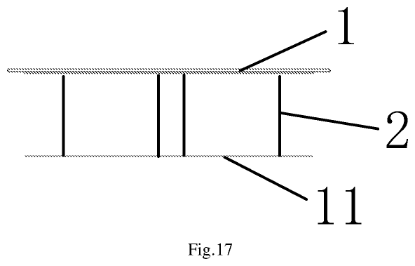

As shown in FIGS. 15 to 17, this embodiment provides a broadband dual-polarization filtering base station antenna unit. The antenna unit comprises four dipole arms, four parasitic branches, a dielectric plate 1 and a feed structure 2. The four dipole arms are the first dipole arm 3, the second dipole arm 4, the third dipole arm 5 and the fourth dipole arm 6. The four parasitic branches are the first parasitic branch 7, the second parasitic branch 8, the third parasitic branch 9, and the fourth parasitic branch 10. The first dipole arm 3, the second dipole arm 4, the third dipole arm 5 and the fourth dipole arm 6 correspond to the first parasitic branch 7, the second parasitic branch 8, the third parasitic branch 9 and the fourth parasitic branch 10 respectively. The four dipole arms and the four parasitic branches may be placed on the upper layer of the dielectric plate 1 by printing, die-casting etc. to form the radiators of the antenna unit.

Further, the first dipole arm 3 and the second dipole arm 4 are arranged oppositely to form +45° polarized dipole arms to become a dipole. The third dipole arm 5 and the fourth dipole arm 6 are arranged oppositely to form −45° polarized dipole arms to become another dipole. Because the four dipole arms are all arc-shaped structures, two dipoles form a bowl-shaped dipole. The first dipole arm 3 is coupled to the first parasitic branch 7. The second dipole arm 4 is coupled to the second parasitic branch 8. The third dipole arm 5 is coupled to the third parasitic branch 9. The fourth dipole arm 6 is coupled to the fourth parasitic branch 10. By adding parasitic branches near the bowl-shaped dipole, the bandwidth of the antenna unit and the integrated filtering performance are increased.

In this embodiment, the feed structure 2 comprises four coaxial lines. The upper ends of the four coaxial lines are connected to the first dipole arm 3, the second dipole arm 4, the third dipole arm 5, and the fourth dipole arm 6 respectively. The lower ends of the four coaxial lines are connected to the reflector 11. The entire antenna unit has the characteristics of stable pattern, wide operating bandwidth and high filtering performance.

### Embodiment 8

This embodiment provides a communication device. The communication device is a transmitting and receiving device of a wireless communication system, comprising the antenna unit of any one of the above Embodiments 1, 6, and 7, or comprising the antenna array of any one of the above embodiments 2 to 5. The size of the relevant structures may be adjusted according to requirements to adapt to different frequency bands. Due to the filtering characteristics of the antenna unit or antenna array, it is particularly suitable for open and complex communication scenarios. It also benefits from the integration of the filtering characteristics and radiation characteristics of the antenna unit or antenna array, and it is also suitable for all-in-one and integration of communication equipment.

In summary, not only the radiation performance of the antenna unit may achieve high roll-off filtering characteristics and high polarization isolation, but also to a great extent ensuring that no introduction of additional insertion loss and occupied area caused by redundant structures, and the bandwidth may be expanded, the height reduced, and a stable pattern in a wide frequency band is achieved.

The above are only preferred embodiments of the present invention patent, but the scope of protection of the present invention patent is not limited to this. Equivalent replacements or changes made by a skilled person familiar with the technical field, within the scope disclosed in the present invention patent, according to the technical solutions of the present patent invention and its inventive concept, all belong to the scope of protection of the present invention patent.

1. A broadband dual-polarization filtering base station antenna unit, characterized in that, comprising four dipole arms, four parasitic branches and a feed structure, wherein two of the dipole arms are arranged oppositely, the other two dipoles are also arranged oppositely, the four dipole arms correspond to the four parasitic branches respectively, each dipole arm is coupled to a corresponding parasitic branch, the feed structure is connected with the four dipole arms.

2. The broadband dual-polarization filtering base station antenna unit according to claim 1, characterized in that, a size of each dipole arm is used to control a frequency position of an upper stopband radiation null, and a size of each parasitic branch is used to control a frequency position of a lower stopband radiation null, a coupling amount between each dipole arm and the corresponding parasitic branch and a size of the parasitic branches are used to achieve independent controllable band-pass filtering of a radiation suppression null.

3. The broadband dual-polarization filtering base station antenna unit according to claim 2, characterized in that, the coupling amount between each dipole arm and the corresponding parasitic branch is controlled by the size of the dipole arm and a spacing between the dipole arm and the corresponding parasitic branch.

4. The broadband dual-polarization filtering base station antenna unit according to claim 1, characterized in that, the feed structure comprises two mutually orthogonal baluns, each balun comprises a feed line, a lower end of the feed line is connected with a coaxial line.

5. The broadband dual-polarization filtering base station antenna unit according to claim 4, characterized in that, each balun further comprises a substrate, the feed line is arranged on a front surface of the substrate, and a back surface of the substrate is a ground plane.

6. The broadband dual-polarization filtering base station antenna unit according to claim 5, characterized in that, a height of the substrate is a quarter of a wavelength corresponding to a center frequency of the antenna unit.

7. The broadband dual-polarization filtering base station antenna unit according to claim 1, characterized in that, the parasitic branches are U-shaped structures, C-shaped structures, V-shaped structures or top hat-shaped structures.

8. The broadband dual-polarization filtering base station antenna unit according to claim 1, characterized in that, the antenna unit is in a crossed dipole form, a bowl-shaped dipole form, a slot antenna form or a patch antenna form.

9. A base station antenna array, characterized in that, comprising at least two antenna units according to claim 1.

10. A communication device, characterized in that, comprising the antenna unit according to claim 1.

11. A communication device comprising the antenna array according to claim 9.
